(19) United States
(12) Patent Application Publication
(10) Pub. No.: US 2020/0101566 A1
(43) Pub. Date: Apr. 2, 2020

(54) System and Method for Visualizing Laser Energy Distributions Provided by Different Near Field Scanning Patterns

(71) Applicant: IPG Photonics Corporation, Oxford, MA (US)

(72) Inventors: Iurii V. Markushov, Shrewsbury, MA (US); Mustafa Coskun, Chestnut Hill, MA (US); Dmitry Novikov, Avon, CT (US)

(21) Appl. No.: 16/585,131

(22) Filed: Sep. 27, 2019

Related U.S. Application Data
(60) Provisional application No. 62/737,538, filed on Sep. 27, 2018.

(51) Int. Cl. B23K 26/70; B23K 26/035; B23K 26/062; B23K 26/082; H01S 3/00

(52) U.S. Cl. CPC B23K 26/70; B23K 26/035; H01S 3/0014; B23K 26/082; B23K 26/062

(57) ABSTRACT

A system and method may be used to visualize laser energy distributions within one or more laser movements generated by a scanning laser processing head. The system and method determine laser energy distributions at a plurality of locations within the laser movement(s) based at least in part on received laser processing parameters and laser movement parameters. A visual representation of the laser energy distributions may then be displayed to allow the user to visualize and select or define the appropriate pattern and parameters for a laser processing operation. The visualization system and method may be used to predict actual laser energy distributions in a laser processing operation by visualizing the laser energy distributions before the laser processing operation and/or to troubleshoot a laser processing operation by visualizing the laser energy distributions after the laser processing operation.

### RELATED APPLICATIONS

The present application claims the benefit of U.S. Provisional Application Ser. No. 62/737,538 filed Sep. 27, 2018, entitled SYSTEM AND METHOD FOR VISUALIZING LASER ENERGY DISTRIBUTIONS PROVIDED BY DIFFERENT NEAR FIELD SCANNING PATTERNS, which is fully incorporated herein by reference.

### TECHNICAL FIELD

The present disclosure relates to laser processing and more particularly, to a system and method for visualizing laser energy distributions provided by different near field scanning patterns.

### BACKGROUND INFORMATION

Lasers such as fiber lasers are often used for materials processing applications such as welding. A conventional laser welding head includes a collimator for collimating laser light and a focus lens for focusing the laser light to a target area to be welded. The beam may be moved in various patterns to facilitate welding two structures, for example, using a stir welding or “wobbler” technique. Various techniques may be used to move the beam in the near field (i.e., near field scanning) while also moving or translating the laser processing head or workpiece along the weld location. These near field scanning techniques include, for example, rotating the beam using rotating prism optics to form a rotating or spiral pattern and pivoting or moving the entire weld head on an X-Y stage to form a zig zag pattern. Another technique for moving the beam more quickly and precisely includes using movable mirrors to provide wobble patterns with the beam, for example, as disclosed in greater detail in U.S. Patent Application Publication No. 2016/0368089, which is commonly owned and fully incorporated herein by reference.

Moving the beam in different near field scanning patterns or “wobble” patterns along a workpiece may provide a favorable distribution of laser energy, particularly in welding applications. The different patterns result in different laser energy distributions on the workpiece depending on various process parameters and beam movement parameters. Existing systems, however, do not provide a way for the user to visualize (e.g., prior to a laser processing operation) the various laser energy distributions likely to result from these parameters and thus do not allow the user to make an informed decision on the pattern and/or parameters most suitable for a particular application.

### BRIEF DESCRIPTION OF THE DRAWINGS

These and other features and advantages will be better understood by reading the following detailed description, taken together with the drawings wherein:

FIG. 1 is a schematic block diagram of a laser welding system capable of being used with a system and method for visualizing laser energy distributions provided by different near field scanning patterns, consistent with an embodiment of the present disclosure.

FIG. 2 is a schematic diagram of a focused laser beam with a relatively small range of movement provided by dual mirrors for purposes of wobbling, consistent with an embodiment of the present disclosure.

FIGS. 3A-3D are schematic diagrams illustrating different wobble patterns together with micrographs of sample welds formed by those wobble patterns, consistent with an embodiment of the present disclosure.

FIGS. 4 and 5 are perspective views of a laser welding head with a collimator module, wobbler module, and core block module assembled together and emitting a focused beam, consistent with an embodiment of the present disclosure.

FIG. 6 is a flow chart illustrating a method for visualizing laser energy distributions provided by different near field scanning patterns, consistent with embodiments of the present disclosure.

FIG. 6A is a diagram illustrating one example of calculating laser energy distributions, consistent with embodiments of the present disclosure.

FIG. 7 is an illustration of an embodiment of a user interface for visualizing laser energy distributions provided by different near field scanning patterns.

FIG. 8 is an illustration of another embodiment of a user interface for visualizing laser energy distributions.

FIG. 9 is an illustration of a further embodiment of a user interface for visualizing laser energy distributions.

FIG. 9A is an illustration of a user interface for defining a laser movement pattern for use in a system and method for visualizing laser energy distributions, consistent with another embodiment.

### DETAILED DESCRIPTION

A system and method, consistent with embodiments of the present disclosure, may be used to visualize laser energy distributions within one or more laser movements generated by a scanning laser processing head. The system and method determine laser energy distributions at a plurality of locations within the laser movement(s) based at least in part on received laser processing parameters and laser movement parameters. A visual representation of the laser energy distributions may then be displayed to allow the user to visualize and select or define the appropriate pattern and parameters for a laser processing operation. The visualization system and method may be used to predict actual laser energy distributions in a laser processing operation by visualizing the laser energy distributions before the laser processing operation and/or to troubleshoot a laser processing operation by visualizing the laser energy distributions after the laser processing operation.

In one example, the laser energy distribution visualization system and method may be used with a laser welding head with movable mirrors, which performs welding operations with wobble patterns. The movable mirrors provide a wobbling movement of one or more beams within a relatively small field of view (also referred to as near field scanning), for example, defined by a scan angle of 1-2°. The movable mirrors may be galvanometer mirrors that are controllable by a control system including a galvo controller. The laser welding head may also include a diffractive optical element to shape the beam or beams being moved.

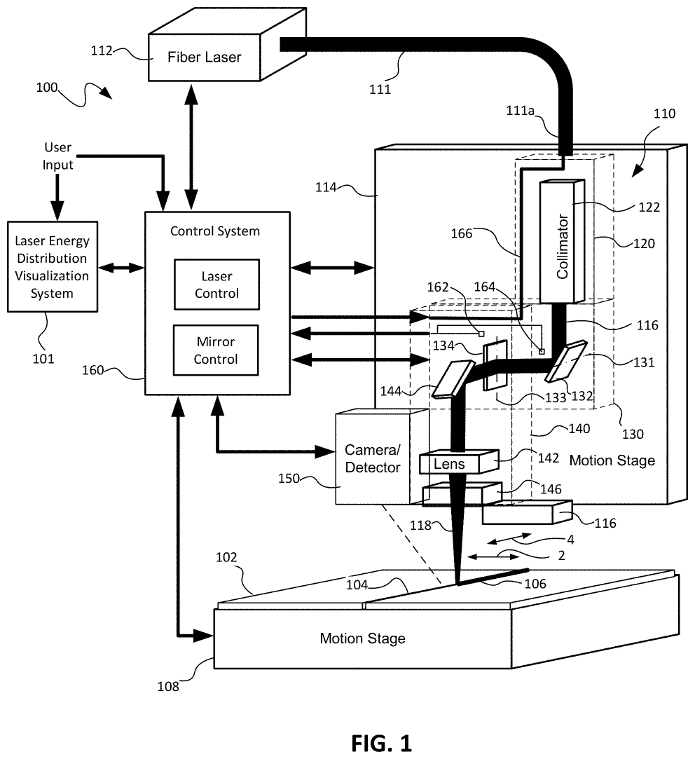

Referring to FIG. 1, a laser energy distribution visualization system 101, consistent with the embodiments of the present disclosure, may be used with a laser welding system 100 including a laser welding head 110 coupled to an output fiber 111 of a fiber laser 112 (e.g., with a connector 111a). The laser welding head 110 may be used to perform welding on a workpiece 102, for example, by welding a seam 104 to form a weld bead 106. The laser welding head 110 and/or the workpiece 102 may be moved or translated relative to each other along the direction of the seam 104. The laser welding head 110 may be located on a motion stage 114 for moving or translating the welding head 110 relative to the workpiece 102 along at least one axis, for example, along the length of the seam 104. Additionally, or alternatively, the workpiece 102 may be located on a motion stage 108 for moving or translating the workpiece 102 relative to the laser welding head 110. As the laser welding head 110 and/or the workpiece 102 are translated relative to each other, the laser welding head 110 causes smaller laser movements on the workpiece 102 referred to as near field scanning or wobbling.

The laser energy distribution visualization system 101 may be used to visualize the laser energy distributions on the workpiece 102 based on laser processing parameters and laser movement parameters, as will be described in greater detail below. The laser energy distribution visualization system 101 may include any computer system programmed to determine laser energy distributions at a plurality of locations within the laser movement(s) based at least in part on received laser processing parameters and laser movement parameters. The laser energy distribution visualization system 101 may also include a display or other visual output for displaying a visual representation of the laser energy distributions. Although the laser energy distribution visualization system 101 is described in the context of a particular embodiment of the laser welding system 100, the visualization system 101 may be used with any type of laser processing system.

The fiber laser 112 may include an Ytterbium fiber laser capable of generating a laser in the near infrared spectral range (e.g., 1060-1080 nm). The Ytterbium fiber laser may be a single mode or multi-mode continuous wave Ytterbum fiber laser capable of generating a laser beam with power up to 1 kW in some embodiments and higher powers up to 50 kW in other embodiments. Examples of the fiber laser 112 include the YLR SM Series or YLR HP Series lasers available from IPG Photonics Corporation. The fiber laser 112 may also include an adjustable mode beam (AMB) laser such as the YLS-AMB Series lasers available from IPG Photonics Corporation. The fiber laser 112 may also include a multi-beam fiber laser, such as the type disclosed in International Application No. PCT/US2015/45037 filed 13 Aug. 2015 and entitled Multibeam Fiber Laser System, which is capable of selectively delivering one or more laser beams through multiple fibers.

The laser welding head 110 generally includes a collimator 122 for collimating the laser beam from the output fiber 111, at least first and second movable mirrors 132, 134 for reflecting and moving the collimated beam 116, and a focus lens 142 for focusing and delivering a focused beam 118 to the workpiece 102. In the illustrated embodiment, a fixed mirror 144 is also used to direct the collimated laser beam 116 from the second movable mirror 134 to the focus lens 142. The collimator 122, the movable mirrors 132, 134, and the focus lens 142 and fixed mirror 144 may be provided in separate modules 120, 130, 140 that may be coupled together, as will be described in greater detail below. The laser welding head 110 may also be constructed without the fixed mirror 144, for example, if the mirrors 132, 134 are arranged such that the light is reflected from the second mirror 134 toward the focus lens 142.

The movable mirrors 132, 134 are pivotable about different axes 131, 133 to cause the collimated beam 116 to move and thus to cause the focused beam 118 to move (e.g., wobble) relative to the workpiece 102 in at least two different perpendicular axes 2, 4. The movable mirrors 132, 134 may be galvanometer mirrors that are movable by galvo motors, which are capable of reversing direction quickly. In other embodiments, other mechanisms may be used to move the mirrors such as stepper motors. Using the movable mirrors 132, 134 in the laser welding head 110 allows the laser beam 118 to be moved precisely, controllably and quickly for purposes of beam wobbling without having to move the entire welding head 110 and without using rotating prisms.

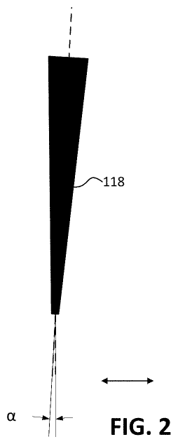

In an embodiment of the welding head 110, movable mirrors 132, 134 move the beam 118 within only a relatively small field of view (e.g., less than 30×30 mm) by pivoting the beam 118 within a scan angle α of less than 10° and more particularly about 1-2°, as shown in FIG. 2, thereby allowing the beam to wobble. In contrast, conventional laser scan heads generally provide movement of the laser beam within a much larger field of view (e.g., larger than 50×50 mm and as large as 250×250 mm) and are designed to accommodate the larger field of view and scan angle. Thus, the use of the movable mirrors 132, 134 to provide only a relatively small field of view in the laser welding head 110 is counter-intuitive and contrary to the conventional wisdom of providing a wider field of view when using galvo scanners. Limiting the field of view and the scan angle provides advantages when using galvo mirrors in the welding head 110, for example, by enabling faster speeds, allowing use with less expensive components such as lenses, and by allowing use with accessories such as air knife and/or gas assist accessories.

The focus lens 142 may include focus lenses known for use in laser welding heads and having a variety of focal lengths ranging, for example, from 100 mm to 1000 mm. Conventional laser scan heads use multi-element scanning lenses, such as an F theta lens, a field flattening lens, or a telecentric lens, with much larger diameters (e.g., a 300 mm diameter lens for a 33 mm diameter beam) to focus the beam within the larger field of view. Because the movable mirrors 132, 134 are moving the beam within a relatively small field of view, a larger multi-element scanning lens (e.g., an F theta lens) is not required and not used. In one example embodiment of the welding head 110 consistent with the present disclosure, a 50 mm diameter plano convex F300 focus lens may be used to focus a beam having a diameter of about 40 mm for movement within a field of view of about 15×5 mm. The use of the smaller focus lens 142 also allows additional accessories, such as air knife and/or gas assist accessories, to be used at the end of the welding head 110. The larger scanning lenses required for conventional laser scan heads limited the use of such accessories.

Other optical components may also be used in the laser welding head 110 such as a beam splitter for splitting the laser beam to provide at least two beam spots for welding (e.g., on either side of the weld). Additional optical components may also include diffractive optics and may be positioned between the collimator 122 and the mirrors 132, 134.

A protective window 146 may be provided in front of the lens 142 to protect the lens and other optics from the debris produced by the welding process. The laser welding head 110 may also include a welding head accessory 116, such as an air knife for providing high velocity air flow across the protective window 146 or focus lens 142 to remove the debris and/or a gas assist accessory to deliver shield gas coaxially or off-axis to the weld site to suppress weld plume. Thus, the laser welding head 110 with movable mirrors is capable of being used with existing welding head accessories.

The illustrated embodiment of the laser welding system 100 also includes a detector 150, such as a camera, for detecting and locating the seam 104, for example, at a location in advance of the beam 118. Although the camera/detector 150 is shown schematically at one side of the welding head 110, the camera/detector 150 may be directed through the welding head 110 to detect and locate the seam 104.

The illustrated embodiment of the laser welding system 100 further includes a control system 160 for controlling the fiber laser 112, the positioning of the movable mirrors 132, 134, and/or the motion stages 108, 114, for example, in response to sensed conditions in the welding head 110, a detected location of the seam 104, and/or movement and/or a position of the laser beam 118. The laser welding head 110 may include sensors such as first and second thermal sensors 162, 164 proximate the respective first and second movable mirrors 132, 134 to sense thermal conditions. The control system 160 is electrically connected to the sensors 162, 164 for receiving data to monitor the thermal conditions proximate the movable mirrors 132, 134. The control system 160 may also monitor the welding operation by receiving data from the camera/detector 150, for example, representing a detected location of the seam 104.

The control system 160 may control the fiber laser 112, for example, by shutting off the laser, changing the laser parameters (e.g., laser power), or adjusting any other adjustable laser parameter. The control system 160 may cause the fiber laser 112 to shut off in response to a sensed condition in the laser welding head 110. The sensed condition may be a thermal condition sensed by one or both of the sensors 162, 164 and indicative of a mirror malfunction resulting in high temperatures or other conditions caused by the high power laser.

The control system 160 may cause the fiber laser 112 to shut off by triggering a safety interlock. A safety interlock is configured between the output fiber 111 and the collimator 122 such that the safety interlock condition is triggered and the laser is shut off when the output fiber 111 is disconnected from the collimator 122. In the illustrated embodiment, the laser welding head 110 includes an interlock path 166 that extends the safety interlock feature to the movable mirrors 132, 134. The interlock path 166 extends between the output fiber 111 and the control system 160 to allow the control system 160 to trigger the safety interlock condition in response to potentially hazardous conditions detected in the laser welding head 110. In this embodiment, the control system 160 may cause the safety interlock condition to be triggered via the interlock path 166 in response to a predefined thermal condition detected by one or both sensors 162, 164.

The control system 160 may also control the laser parameters (e.g., laser power) in response to movement or a position of the beam 118 without turning off the laser 112. If one of the movable mirrors 132, 134 moves the beam 118 out of range or too slowly, the control system 160 may reduce the laser power to control the energy of the beam spot dynamically to avoid damage by the laser. The control system 160 may further control selection of laser beams in a multi-beam fiber laser.

The control system 160 may also control the positioning of the movable mirrors 132, 134 in response to the detected location of the seam 104 from the camera/detector 150, for example, to correct the position of the focused beam 118 to find, track and/or follow the seam 104. The control system 160 may find the seam 104 by identifying a location of the seam 104 using the data from the camera/detector 150 and then moving one or both of the mirrors 132, 134 until the beam 118 coincides with the seam 104. The control system 160 may follow the seam 104 by moving one or both of the mirrors 132, 134 to adjust or correct the position of the beam 118 continuously such that the beam coincides with the seam 104 as the beam 118 moves along the seam to perform the weld. The control system 160 may also control one or both of the movable mirrors 132, 134 to provide the wobble movement during welding, as described in greater detail below.

The control system 160 thus includes both laser control and mirror control working together to control both the laser and the mirrors together. The control system 160 may include, for example, hardware (e.g., a general purpose computer) and software known for use in controlling fiber lasers and galvo mirrors. Existing galvo control software may be used, for example, and modified to allow the galvo mirrors to be controlled as described herein. The control system 160 may be in communication with the laser energy distribution visualization system 101, for example, to receive selected parameters. The laser processing parameters and laser movement parameters may be input into the control system 160 and then transferred to the visualization system 101 or may be input into the visualization system 101 and then transferred to the control system 160. Alternatively, the laser energy distribution visualization system 101 may be integrated with the control system 160.

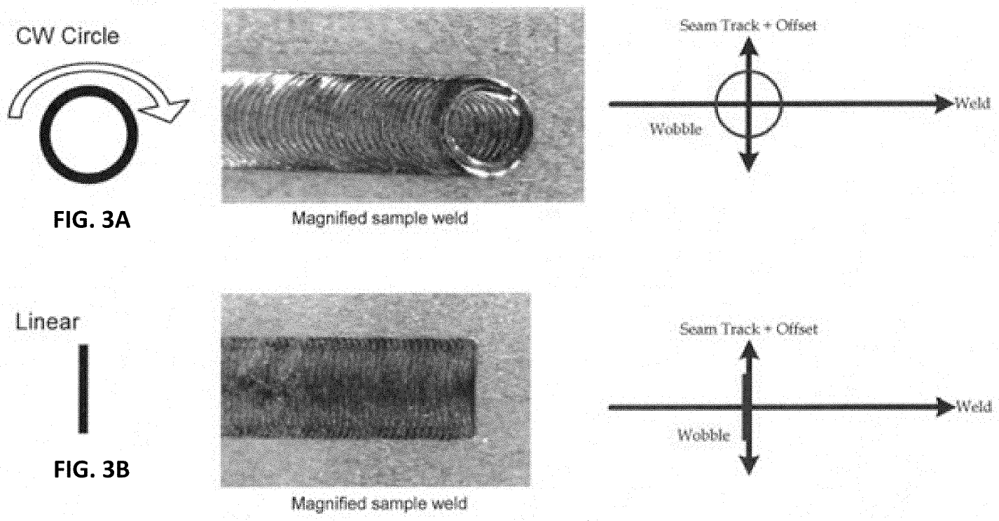

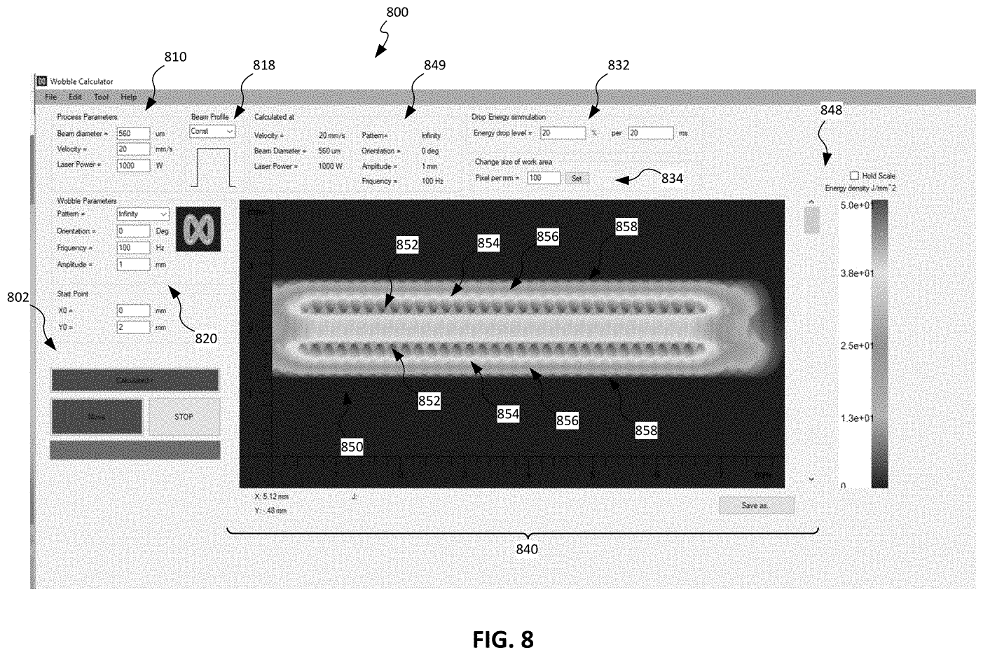

FIGS. 3A-3D illustrate examples of wobble patterns that may be used to perform stir welding of a seam together with sample welds formed thereby. As used herein, “wobble” refers to reciprocating movement of a laser beam (e.g., in one or two axes) and within a relatively small field of view defined by a scan angle of less than 10°. FIG. 3A shows a clockwise circular pattern, FIG. 3B shows a linear pattern, FIG. 3C shows a figure 8 pattern, and FIG. 3D shows an infinity pattern. Although certain wobble patterns are illustrated, other wobble patterns are within the scope of the present disclosure. One advantage of using the movable mirrors in the laser welding head 110 is the ability to move the beam according to a variety of different wobble patterns.

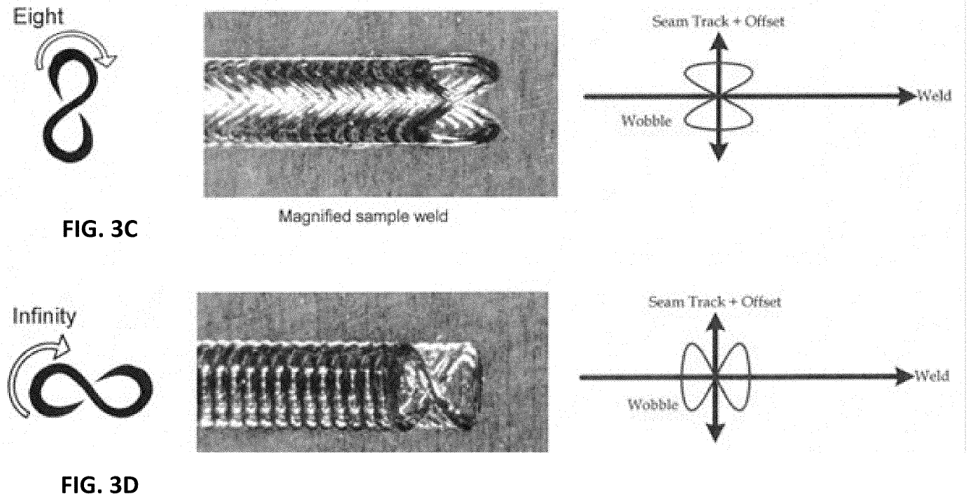

FIGS. 4 and 5 illustrate an example embodiment of a scanning laser welding head 410 in greater detail. Although one specific embodiment is shown, other embodiments of the laser welding head and systems and methods described herein are within the scope of the present disclosure. As shown in FIG. 4, the laser welding head 410 includes a collimator module 420, a wobbler module 430, and a core block module 440. The wobbler module 430 includes the first and second movable mirrors as discussed above and is coupled between the collimator module 420 and the core block module 440.

The collimator module 420 may include a collimator (not shown) with a fixed pair of collimator lenses such as the type known for use in laser welding heads. In other embodiments, the collimator may include other lens configurations, such as movable lenses, capable of adjusting the beam spot size and/or focal point. The wobbler module 430 may include first and second galvanometers (not shown) for moving galvo mirrors (not shown) about different perpendicular axes. Galvanometers known for use in laser scanning heads may be used. The galvanometers may be connected to a galvo controller (not shown). The galvo controller may include hardware and/or software for controlling the galvanometers to control movement of the mirrors and thus movement and/or positioning of the laser beam. Known galvo control software may be used and may be modified to provide the functionality described herein, for example, the seam finding, the wobbler patterns, and communication with the laser. The core block module 440 may include a fixed mirror (not shown) that redirects the beam received from the wobbler module 430 to a focus lens and then to the workpiece.

FIGS. 4 and 5 show the assembled laser welding head 410 with each of the modules 420, 430, 440 coupled together and emitting a focused beam 418. A laser beam coupled into the collimator module 420 is collimated and the collimated beam is directed to the wobbler module 430. The wobbler module 430 moves the collimated beam using the mirrors and directs the moving collimated beam to the core block module 440. The core block module 440 then focuses the moving beam and the focused beam 418 is directed to a workpiece (not shown).

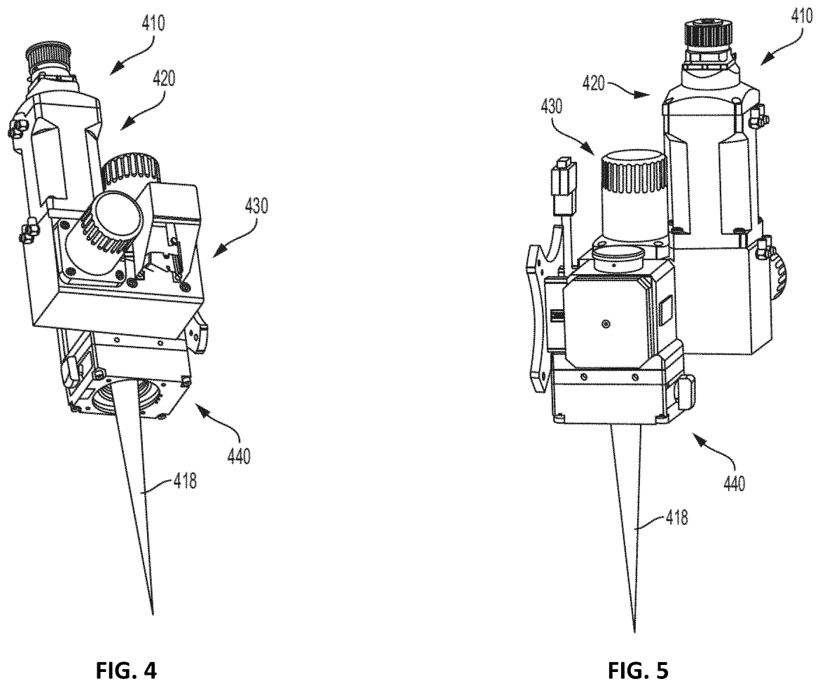

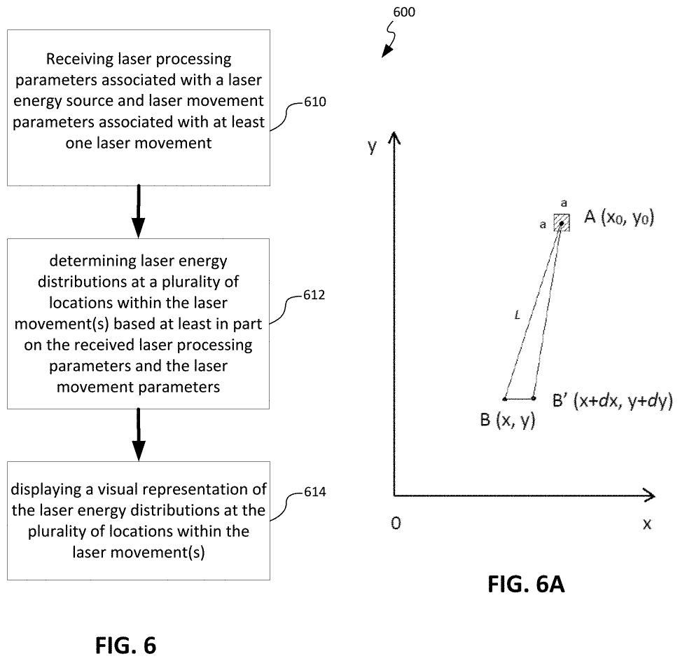

Referring to FIG. 6, a method 600 for visualizing laser energy distribution is shown and described. The laser energy distribution system 101 shown in FIG. 1 may include any computer system programmed to perform the method 600 shown in FIG. 6 including, without limitation, a general purpose computer running executable software. The method 600 includes receiving 610 laser processing parameters associated with a laser energy source and laser movement parameters associated with one or more laser movements. The parameters may be input by a user with a graphical user interface, for example, as described in greater detail below.

The laser processing parameters may include, for example, a beam profile, a beam diameter, a velocity and a laser power. The beam profile may include, for example, a Gaussian profile, a constant or “flat top” profile, or a custom designed beam profile. The velocity may include the velocity of the laser processing head moving relative to the workpiece and/or the velocity of the workpiece moving relative to the laser processing head. The laser processing parameters may also include laser power parameters for an adjustable mode beam (AMB) laser, which provides independent and dynamic control over the beam profile by controlling power in the core and/or outer ring. The AMB laser power parameters may include laser power in the core and laser power in the outer ring.

The laser movement parameters may include, for example, the movement pattern, movement orientation, movement frequency, and movement amplitude. In one embodiment, the movement pattern is a wobble pattern with a wobble frequency and a wobble amplitude. Movement patterns may be selected from a group of predefined movement patterns (e.g., circle pattern, line pattern, figure eight pattern, or infinity pattern). Movement patterns may also be defined by the user, for example, using an advanced user mode interface, as will be described in greater detail below.

The method 600 also includes determining 612 laser energy distributions at a plurality of locations within the laser movement(s) based at least in part on the received parameters. Determining the laser energy distributions includes, for example, calculating a beam exposure time for each of the irradiation locations (i.e., how long is beam above each location) based on the laser processing parameters and the laser movement parameters. An energy density is then calculated for each of the irradiation locations based on the beam exposure time and using a power distribution curve.

According to one example of calculating laser energy distribution, consider a small square with a side of a mm and center point A(x₀, y₀), as shown in FIG. 6A. If α<<Beam Diameter, the energy density can be assumed to be constant there. If the source is at point B(x, y) and power distribution is described by function f(x), when point B(x, y) is moved to B′(x+dx, y+dy) in small time dt, then power density ρ in the square can be found by equation (1).

$$d ρ = \frac{f ( L ( t ) )}{{a}^{2}} \cdot dt , \qquad ( 1 )$$

where L(t) it is distance between point A and B and can be described by equation (2)

L(t)={square root over ((x(t)−x₀)²+(y(t)−y₀)²)} (2)

To calculate total density, equation (1) is integrated by time as follows:

$$ρ = \frac{1}{{a}^{2}} {\int }_{0}^{t} f ( L ( t ) ) \cdot dt \qquad ( 3 )$$

In one example, distribution of power f(x) may be described by the gauss function g(r):

$$g ( r ) = \frac{1}{σ \sqrt{2 π}} {e}^{- \frac{{r}^{2}}{2 {σ}^{2}}} , \qquad ( 4 )$$

where r is distance from beam center and σ is a parameter depended from beam diameter. Other calculations and techniques for determining energy density distributions are also possible and within the scope of the present disclosure.

The method 600 further includes displaying 614 a visual representation of the laser energy distributions at the irradiation locations within the laser movement(s). The laser energy distributions may be displayed, for example, for a single movement pattern and for a series of consecutive movement patterns formed as the patterns are translated. To display the visual representation, the calculated energy density for each of the irradiation locations may be transformed into a color and the color may be displayed in the respective irradiation locations on the pattern and/or series of patterns. The colors may include a spectrum of colors representing a range of energy densities. The spectrum of colors may include, for example, blue representing the lowest energy densities, red representing the highest energy densities, and green representing intermediate energy densities. Other colors or additional colors may also be used.

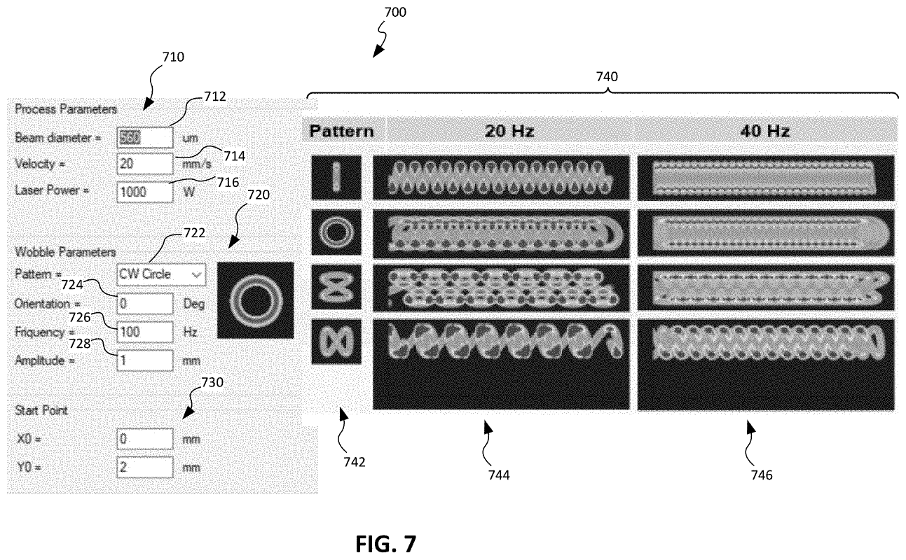

Referring to FIG. 7, an example of a graphical user interface 700 for the laser energy distribution visualization system is shown and described. The graphical user interface 700 may be displayed on a screen of a display device, for example, coupled to the computer system running the visualization system software.

In this example, the user interface 700 provides for inputting process parameters 710 including a beam diameter (μm) 712, a velocity (mm/s) 714 of the laser processing head and/or workpiece moving relative to each other, and a laser power (W) 716. The user interface 700 also provides for inputting wobble parameters 720 including a predefined wobble pattern 722, a pattern orientation (degrees) 724, a wobble frequency (Hz) 726, and a wobble amplitude (mm) 728. The predefined wobble patterns may include, for example, a clockwise circle, a counterclockwise circle, a horizontal line, a vertical line, a figure 8, and an infinity pattern. The parameters may also include coordinates 730 (e.g., in an X, Y axis) for a start point for the wobble pattern. Other patterns and parameters are also contemplated and within the scope of the present disclosure. For example, the laser processing parameters may also include beam shape and/or profile.

The graphical user interface 700 also includes a visualization section 740 showing the visual representations of the laser energy distributions for the different laser movements (e.g., different patterns) with the calculated laser energy density shown with different colors. The visual representations may include the single pattern laser energy distribution 742 as well as the moving laser energy distributions 744, 746 for a series of patterns repeated over multiple periods (i.e., as the laser processing head and/or workpiece move relative to each other). In this example, the red color shows the irradiation locations with the highest energy density and the blue color shows the irradiation locations with the lowest energy density.

In the illustrated example, different sets of visual representations are shown together for different frequency parameters. For example, each of the laser energy distributions is shown for a 20 Hz wobble frequency and a 40 Hz wobble frequency to allow the user to compare the laser energy distributions at the different frequencies. The visualization section 740 may also show different sets of visual representations for other parameters to allow comparison. Any number of different patterns may be visualized and compared.

After visualizing and comparing the laser energy distributions, a user may select the desired process parameters and/or wobble parameters and enter the parameters (e.g., into the control system 160) to initiate a laser processing operation based on the desired parameters. The process parameters 710 and/or wobble parameters 722 may also be entered into the interface 700 following a laser processing operation for troubleshooting the laser processing operation.

FIG. 8 shows another example of a graphical user interface 800 for the laser energy distribution visualization system. In this example, the laser energy distribution for only one selected pattern is displayed. In addition to selecting the process parameters 810 and wobble parameters 820, as described above, this user interface 800 includes a beam profile parameter 818 that allows the user to select a beam profile including, without limitation, a constant or “top hat” profile and a gaussian profile. The selected beam profile may then be used together with the other selected process parameters 810 and the selected wobble parameters 820 to calculate the laser energy densities and generate the laser energy distributions to be displayed.

After selecting the parameters, the calculation buttons 802 may be used to initiate the calculations and cause the resulting laser energy distributions to be displayed in the visualization section 840. The laser energy distributions may be displayed in the visualization section 840 all at once after the calculations are completed or may be formed to simulate the scanning and moving laser. This embodiment of the user interface 800 also includes a “calculated at” section 849 to display the parameters used to calculate the laser energy densities in the laser energy distribution that is displayed in the visualization section.

This example of the user interface 800 further includes an energy density display setting 848 to allow the user to select a range of energy densities corresponding to the spectrum of colors. In the illustrated example, the spectrum of colors includes the visible spectrum from red to blue with red representing the highest energy density and blue representing zero. In this example, the energy density display setting 848 includes a slider that allows the user to set the highest energy density corresponding to the red color. When the energy density setting is changed, the colors change on the displayed predicted laser energy distribution based on the selected energy density range. This allows a user to better visualize the predicted laser energy density distribution depending on the range of calculated laser energy densities.

In the illustrated example, red represents an energy density of about 50 J/mm², yellow represents an energy density of about 38 J/mm², green represents an energy density of about 25 J/mm², aqua represents an energy density of about 13 J/mm² and blue represents an energy density of 0. The visualization section 840 in this illustrated example shows an energy distribution 850 including red portions 852, a yellow portion 854 bordering and between the red portions 852, a green portion 856 surrounding the yellow portion 854, and an aqua portion 858 bordering the green portion 856. The remainder of the visualization section 840 is blue. From this energy distribution 850, it can be observed that the infinity wobble pattern at the specified parameters forms two lines of higher energy density represented by the red portions 852.

This user interface 800 also includes a work area parameter 834 to allow the user to change the size of the work area (e.g., in pixel per mm). This user interface 800 further includes a drop energy simulation parameter 832 that allows the user to set the percentage of energy drop level per unit of time (e.g., ms), thereby allowing simulation of the loss of energy.

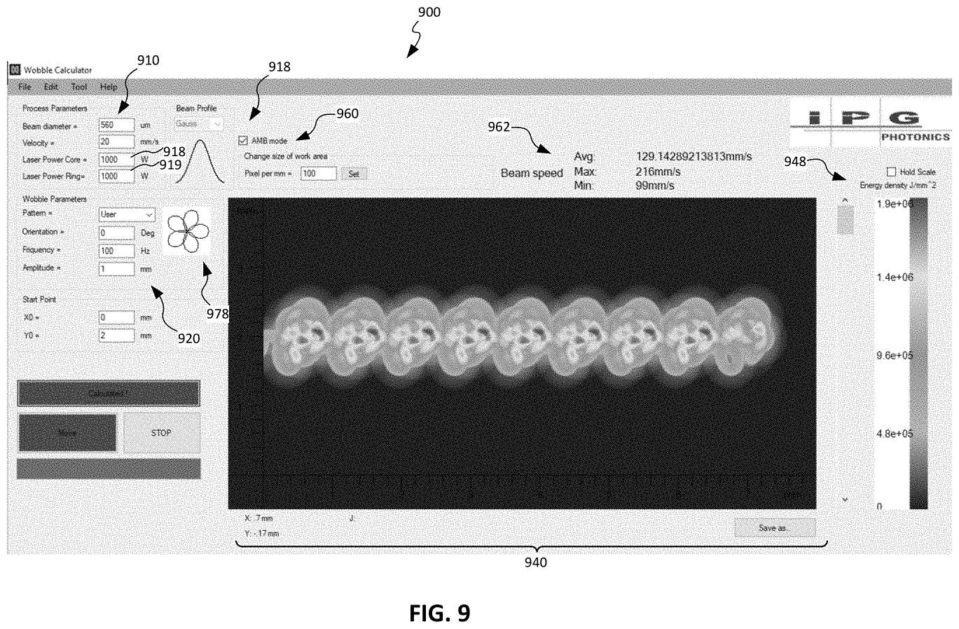

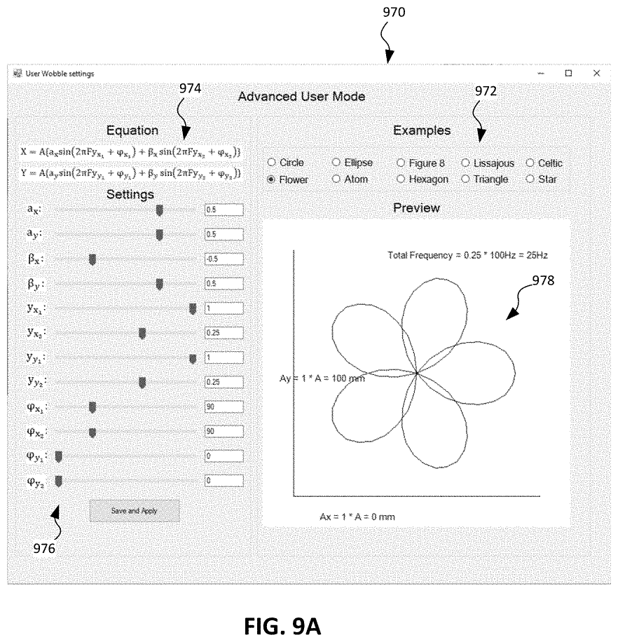

FIG. 9 shows a further example of a graphical user interface 900 for the laser energy distribution visualization system. The interface 900, similar to the interface 800 described above, provides for selection of process parameters 910, beam profile 918, and wobble parameters 920 and an energy density display setting 948. The interface 900 also includes an AMB mode 960 to provide visualizations for an AMB laser. When the AMB mode 960 is activated, the process parameters include a laser power core parameter 918 and a laser power ring parameter 919.

The interface 900 also includes a beam speed section 962 that shows the maximum, minimum and average beam speeds within the pattern. Because laser beam is moving within the wobble pattern while the pattern is moved or translated (i.e., as the laser processing head and/or workpiece move relative to each other), the beam speed may vary at different locations within a pattern. For example, the beam speed will be slower when the beam is moving through a part of the pattern that is opposite to the travel speed of the laser processing head and/or workpiece.

This embodiment of the interface 900 further includes a user-defined wobble pattern option (e.g., Pattern=“User”) allowing the user to define the pattern. In this embodiment, selecting “User” as the wobble pattern in the wobble parameters 920 activates an advanced user mode interface 970, for example, as shown in FIG. 9A. The advanced user mode interface 970 displays pattern examples 972, pattern equations 974 used to generate the patterns, and pattern settings 976 for changing the values of the coefficients in the pattern equations 974. In the example embodiment, the equations 974 represent the voltage signal for controlling movement of each of the mirrors 132, 134 in the wobble laser welding head 110 shown in FIG. 1. The advanced user mode interface 970 also displays the pattern 978 generated by the equations with the settings.

The user may select one of the pattern examples 972 and the pattern 978 will be displayed with the pattern settings 976 used to generate the selected pattern example. The user may then change selected pattern settings 976 to alter the displayed pattern 978. When the user is finished defining the displayed pattern 978, the user may then save and apply the displayed pattern 978 as the user defined pattern for use in the visualization. The user defined pattern 978 may be displayed with the wobble parameters 920 on the interface 900.

Accordingly, a laser energy distribution visualization system and method, consistent with embodiments described herein, allows improved visualization of the laser energy distributions for various welding applications using wobble patterns.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A method for visualizing a laser energy distribution in a laser processing operation performed by a laser processing system including a laser energy source and a scanning laser processing head that provides laser movement, the method comprising:
receiving laser processing parameters associated with the laser energy source and laser movement parameters associated with the laser movement provided by the scanning laser processing head, wherein the laser processing parameters and the laser movement parameters are used in a laser processing operation performed by the laser processing system including the laser energy source and the scanning laser processing head;
determining laser energy distributions at a plurality of locations within the laser movement based at least in part on the received laser processing parameters and the laser movement parameters; and
displaying a visual representation of the laser energy distributions at the plurality of locations within the laser movement, wherein the visual representation of the laser energy distributions is used to troubleshoot the laser processing operation and/or to predict actual laser energy distributions in the laser processing operation.

2. The method of claim 1 further comprising:
performing a laser processing operation on a workpiece using the laser processing system, wherein the laser processing operation is performed using the laser processing parameters and the laser movement parameters that were used to display the visual representation of the laser energy distribution.

3. The method of claim 2 wherein the laser processing operation is performed before using the laser processing parameters and the laser movement parameters to display the visual representation of the laser energy distribution, and wherein the visual representation of the laser energy distributions is used to troubleshoot the laser processing operation.

4. The method of claim 2 wherein the laser processing operation is performed after using the laser processing parameters and the laser movement parameters to display the visual representation of the laser energy distribution, and wherein the visual representation of the laser energy distributions is used to predict laser energy distributions in the laser processing operation.

5. The method of claim 1 wherein the laser movement is within a field of view less than 30×30 mm.

6. The method of claim 1 wherein the laser movement parameters are selected from the group consisting of laser movement pattern, laser movement orientation, laser movement frequency, and laser movement amplitude.

7. The method of claim 1 wherein the laser movement parameters include at least a laser movement pattern.

8. The method of claim 7 wherein the laser movement pattern is selected from the group consisting of a circular pattern, a figure 8 pattern, an infinity pattern, and a line pattern.

9. The method of claim 7 wherein the laser movement pattern is user defined.

10. The method of claim 7 wherein the laser movement parameters further include laser movement frequency and laser movement amplitude.

11. The method of claim 1 wherein the laser processing parameters are selected from the group consisting of beam profile, beam diameter, velocity and laser power.

12. The method of claim 1 wherein determining the laser energy distributions includes calculating a beam exposure time for each of the plurality of locations based on the laser processing parameters and the laser movement parameters and calculating an energy density for each of the plurality of locations based on the beam exposure time.

13. The method of claim 12 wherein displaying the visual representation includes transforming the energy density for each of the plurality of locations into a color and displaying the color in the respective locations on a screen.

14. The method of claim 1 wherein displaying the visual representation includes displaying colors associated with the laser energy distributions in the respective locations on a screen.

15. The method of claim 1 wherein the laser energy distributions are determined for a plurality of laser movement patterns, and wherein the visual representation is displayed for each of the laser movement patterns.

16. A method for visualizing a laser energy distribution in a laser processing operation performed by a laser processing system including a laser energy source and a scanning laser processing head that provides at least one laser movement, the method comprising:
performing a laser processing operation on a workpiece using the laser processing system, wherein the laser processing operation is performed using laser processing parameters associated with the laser energy source and laser movement parameters associated with the at least one laser movement provided by the scanning laser processing head;
inputting the laser processing parameters and the laser movement parameters into a visualization system;
determining laser energy distributions at a plurality of locations within the at least one laser movement based at least in part on the laser processing parameters and the laser movement parameters input into the visualization system; and
displaying a visual representation of the laser energy distributions at the plurality of locations within the laser movement, wherein the visual representation of the laser energy distributions are used to troubleshoot the laser processing operation.

17. A method for visualizing a laser energy distribution in a laser processing operation performed by a laser processing system including a laser energy source and a scanning laser processing head that provides at least one laser movement, the method comprising:
inputting, into a visualization system, laser processing parameters associated with the laser energy source and laser movement parameters associated with the at least one laser movement provided by the scanning laser processing head;
determining laser energy distributions at a plurality of locations within the at least one laser movement based at least in part on the laser processing parameters and the laser movement parameters input into the visualization system;
displaying a visual representation of the laser energy distributions at the plurality of locations within the laser movement; and
performing a laser processing operation on a workpiece using the laser processing system, wherein the laser processing is performed using the laser processing parameters and the laser movement parameters that produced the visual representation of the laser energy distributions.

18. A non-transitory computer readable storage medium comprising computer readable instructions which when executed by a processor, cause the processor to perform the following operations comprising:
receiving laser processing parameters associated with a laser energy source and laser movement parameters associated with at least one laser movement to be generated by a scanning laser processing head, wherein the laser processing parameters and the laser movement parameters are used in a laser processing operation performed by a laser processing system including the laser energy source and the scanning laser processing head;
determining laser energy distributions at a plurality of locations within the laser movement based at least in part on the received laser processing parameters and the laser movement parameters; and
displaying a visual representation of the laser energy distributions at the plurality of locations within the laser movement, wherein the visual representation of the laser energy distributions is used to troubleshoot the laser processing operation and/or to predict actual laser energy distributions in the laser processing operation.

19. The non-transitory computer readable storage medium of claim 21, wherein receiving the laser processing parameters and the laser movement parameters includes communicating with a laser processing system to receive the laser processing parameters and the laser movement parameters input into the laser processing system.

20. A laser welding system comprising:
a fiber laser including an output fiber;
a welding head coupled to the output fiber of the fiber laser, the welding head comprising:
a collimator configured to be coupled to an output fiber of a fiber laser;
at least one movable mirror configured to receive a collimated laser beam from the collimator and to move the beam in at least one axis; and
a focus lens configured to focus the laser beam;
a control system for controlling at least the fiber laser and positions of the at least one mirror; and
a laser energy distribution visualization system programmed to receive laser processing parameters associated with the fiber laser and laser movement parameters associated with at least one laser movement by the at least one mirror in the welding head, to determine laser energy distributions at a plurality of locations within the laser movement based at least in part on the received laser processing parameters and the laser movement parameters, and to display a visual representation of the laser energy distributions at the plurality of locations within the laser movement.

21. The laser welding system of claim 18 wherein the fiber laser includes an Ytterbium fiber laser.

22. The laser welding system of claim 18 wherein the control system is configured to control the at least one mirror to provide a wobble pattern.

23. The laser welding system of claim 18 wherein the control system is configured to control the fiber laser to adjust laser power in response to movement and/or a position of the beam.

24. The laser welding system of claim 18 wherein the at least one movable mirror is configured to move the beam within only a limited field of view defined by a scan angle of about 1-2°
